(19) United States
(12) Patent Application Publication
(10) Pub. No.: US 2017/0004586 A1
(43) Pub. Date: Jan. 5, 2017

(54) COMPUTER PRODUCT, WORK MANAGEMENT METHOD, AND WORK MANAGEMENT SYSTEM

(71) Applicant: FUJITSU LIMITED, Kawasaki-shi (JP)

(72) Inventor: Takeshi Suzuki, Kawasaki (JP)

(21) Appl. No.: 15/189,670

(22) Filed: Jun. 22, 2016

(30) Foreign Application Priority Data
Jun. 30, 2015 (JP) 2015-131717

(51) Int. Cl. G06Q 40/00; G06Q 10/10; G06K 9/00; H04N 7/18; G11B 27/34; H04N 5/77

(52) U.S. Cl. CPC G06Q 40/125; G11B 27/34; H04N 5/77; G06K 9/00711; H04N 7/183; G06Q 10/1091

(57) ABSTRACT

A non-transitory, computer-readable recording medium stores therein a work management program that causes a computer to execute a process that includes receiving information that specifies a start time and an end time of work; receiving audio data or video data that includes an obtaining time thereof; identifying among the received audio data or video data, audio data or video data for which the obtaining time is between the start time and the end time specified by the received information; and displaying at an area that corresponds to a time interval demarcated by the start time and the end time, a symbol that corresponds to the identified audio data or video data.

### CROSS REFERENCE TO RELATED APPLICATIONS

This application is based upon and claims the benefit of priority of the prior Japanese Patent Application No. 2015-131717, filed on Jun. 30, 2015, the entire contents of which are incorporated herein by reference.

### FIELD

The embodiments of the invention relate to a computer product, a work management method, and a work management system.

### BACKGROUND

Industrial engineering (IE) and business field work (BFW) pertain to improving work efficiency. For example, the actions of a subject are directly observed and recorded in detail. To objectively record behavior during work, audio data recording words spoken by the subject and video data recording the actions of the subject are obtained.

According to a related technique, for example, work process information, site information, time information, and video information are obtained, collectively recorded according to a work unit, and managed as work records objectively verifying behavior. According to another technique, the time of a work record discrepancy is calculated, the worker is notified of the time during which the discrepancy occurs in the work record, is asked to recall details of the work, and assists in correcting the discrepancy. For examples of such techniques, refer to Japanese Laid-Open Patent Publication Nos. 2008-84068 and 2008-90351.

Nonetheless, with such conventional techniques, it is difficult to ascertain the work that was being performed when the audio data and video data were recorded.

Therefore, for example, at a meeting after the observation is over, the observer may ask a question about the circumstances of a task and despite the observer playing audio and/or video generated from the audio data and/or video data, the worker may be unable to discern to which task the question pertains.

### SUMMARY

According to an aspect of an embodiment, a non-transitory, computer-readable recording medium stores therein a work management program that causes a computer to execute a process that includes receiving information that specifies a start time and an end time of work; receiving audio data or video data that includes an obtaining time thereof; identifying among the received audio data or video data, audio data or video data for which the obtaining time is between the start time and the end time specified by the received information; and displaying at an area that corresponds to a time interval demarcated by the start time and the end time, a symbol that corresponds to the identified audio data or video data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a work management method according to an embodiment;

FIG. 2 is a diagram depicting an example of system configuration of a work management system 200;

FIG. 3 is a block diagram of an example of hardware configuration of a work management device 101;

FIG. 4 is a diagram depicting an example of the contents of a business task record table 220;

FIG. 5 is a diagram depicting an example of the contents of a confirmation table 230;

FIG. 6 is a diagram depicting an example of a business task record display screen 600;

FIG. 7 is a diagram depicting an example of a detailed display graphic 700;

FIG. 8 is a diagram depicting an example of a data obtaining graphic 800;

FIG. 9 is a diagram depicting an example of a data insertion graphic 900;

FIG. 10 is a diagram depicting an example of a business task detail screen 1000;

FIG. 11 is a diagram depicting an example of a site detail screen 1100;

FIG. 12 is a block diagram of a functional configuration of the work management device 101;

FIG. 13 is a flowchart of an example of a procedure of a data insertion process by the work management device 101;

FIG. 14 is a flowchart of an example of a procedure of a data display process of the work management device 101;

FIG. 15 is a flowchart of an example of a procedure of a business task detail screen creation process of the work management device 101; and

FIG. 16 is a flowchart of an example of a procedure of a confirmation process of the work management device 101.

### DESCRIPTION OF THE INVENTION

Embodiments of a work management program, a work management method, and a work management system according to the present invention will be described in detail with reference to the accompanying drawings.

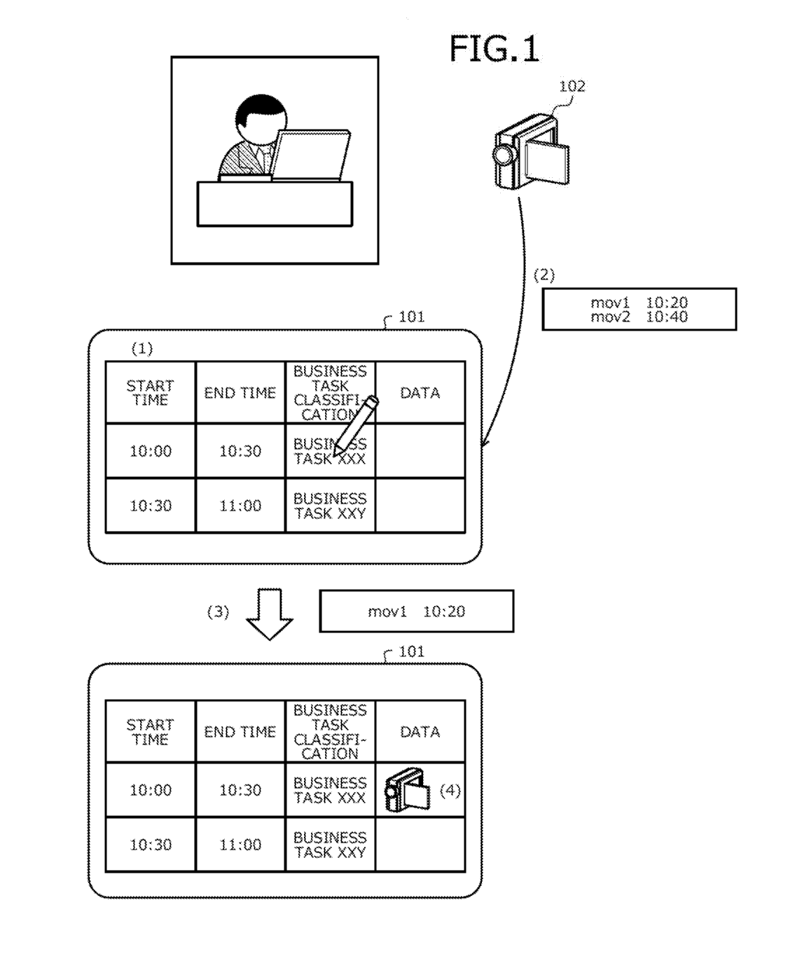

FIG. 1 is a diagram depicting an example of the work management method according to an embodiment. In FIG. 1, a work management device 101 is a computer configured to manage records obtained by observing the work of a subject.

Here, the act of observing is objectively watching and recording the actions of a subject. A subject is a person who performs work and is subject to observation. Therefore, hereinafter, a subject may be indicated as a worker. Work is the work performed by a subject. For example, work may be work in a particular business field and an action performed in the course of business.

The observation of a subject is performed by an observer. Here, an observer is a person who observes a subject. Often one observer observes one subject. In this case, if the observer observes the subject for 1 day, a large volume of data recording the work of the subject is collected.

Audio data and video data included in this data is important information that complements the work records of the subject. Here, audio data is data that records words spoken by the subject while working and is obtained by a recorder, for example. Video data is data that records the actions of the subject while working, is obtained by a camera, for example, and includes still image data recorded by a digital camera and moving image data recorded by a video camera.

To analyze the work of the worker after the observation is over, the observer uses the recorded data and meets with the worker to ask questions that could not be asked while the worker was busy working. The meeting with the worker may be carried out at the end of a single day of work and as necessary, may be carried out a few days later, so as not to disrupt the work of worker.

At the meeting, the observer may ask the worker about the circumstances of the work and despite the observer playing audio and video generated from the audio data and video data recorded during the observation, the worker may be unable to discern to which aspect of the work the question pertains and the meeting may not progress smoothly.

Thus, in the present embodiment, the work management device 101 associates in the audio data or video data obtained by observing the worker, audio data or video data that was obtained during a time period when work was performed and the corresponding time period of the work, and displays the associated audio data or video data represented by a symbol. As a result, the work management device 101 can visually display for which aspect of the work the audio data or video data was recorded. Therefore, the observer can point out to the worker, the aspect of the work being performed when the audio data or video data was recorded.

An example of the work management device 101 according to the embodiment will be described. FIG. 1 depicts an example of a symbol displayed by the work management device 101 to represent video data recorded by the observer using a video camera 102.

(1) The work management device 101 receives information specifying a start time and an end time of work. Here, information specifying a start time and an end time of work is information that can specify the time that work started and ended. For example, the information includes an action classification, a start time, and an end time. Here, an action classification is an identifier for identifying work. Further, when the work management device 101 is configured to associate and store the action classification, start time, and end time, the information specifying the start time and end time of work may include the action classification.

In the example depicted in FIG. 1, a business task is given as an example of work and the work management device 101 associates and stores a business task classification, the start time, and the end time. The work management device 101 receives the business task classification as the information specifying the start and end time of the work. More specifically, for example, the work management device 101 receives a business task XXX as the business task classification.

(2) The work management device 101 receives audio data or video data that includes an obtaining time. Here, an obtaining time is the time when the audio data or video data was recorded. For example, the obtaining time is the time when the recording of the audio data or video data ended. Further, the obtaining time may be a point in time between the time when the recording of the audio data or video data started and the time when the recording ended. Further, for example, the work management device 101 may obtain the audio data or video data from an external recorder, digital camera, or video camera. The work management device 101 may have a built-in recorder, digital camera, or video camera from which the work management device 101 obtains the audio data or video data.

In the example depicted in FIG. 1, the work management device 101 receives from the external video camera 102, video data that includes the obtaining time. More specifically, for example, the work management device 101 receives video data mov1 for which the obtaining time is 10:20, and video data mov2 for which the obtaining is 10:40.

(3) The work management device 101 identifies among the received audio data or video data, the audio data or video data for which the obtaining time is between the start time and end time specified by the received information.

In the example depicted in FIG. 1, the work management device 101 identifies the video data mov1 for which the obtaining time is between the start time 10:00 and the end time 10:30 identified from the business task XXX.

(4) The work management device 101 arranges and displays in an area that corresponds to the time interval demarcated by the start time and the end time, a symbol that corresponds to the identified audio data or video data. Here, the symbol is a symbol that enables visual recognition of the type of data, e.g., audio data or video data. For example, the symbol for audio data may be an icon of a recorder. Further, for video data, the symbol may be an icon of a digital camera in the case of still image data, and an icon of a video camera in the case of moving image data.

Further, in the case of still image data, the symbol may be a thumbnail of the still image and in the case of moving image data, the symbol may be a thumbnail of an image included in the moving image data. Further, in the case of moving image data, the symbol may be of a device that generates a moving image from the moving image data.

In the example depicted in FIG. 1, the work management device 101 arranges and displays in an area that corresponds to a time interval demarcated by the start time 10:00 and the end time 10:30, a digital camera icon corresponding to the video data.

As described, the work management device 101 receives information that specifies the start time and the end time of work, and audio data or video data that includes the obtaining time. The work management device 101 identifies among the audio data or video data, audio data or video data that has an obtaining time that is between the start time and the end time specified by the received information. The work management device 101 arranges and displays in an area that corresponds to the time interval demarcated by the start time and the end time, a symbol that corresponds to the identified audio data or video data.

As a result, the work management device 101 can visually display during which aspect of the work the audio data or video data was recorded. Therefore, the observer can point out to the worker, the aspect of the work being performed when the audio data or video data was recorded.

For example, at the meeting after work observation, the observer presents to the worker, the audio data and/or video data obtained of the worker working and can enquire about the work, enabling the observer to efficiently advance the progress of the meeting.

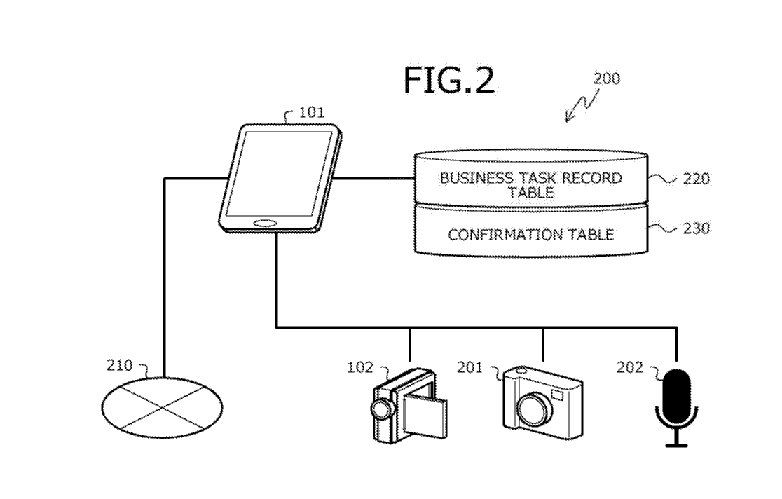

FIG. 2 is a diagram depicting an example of system configuration of a work management system 200. In FIG. 2, the work management system 200 includes the work management device 101, the video camera 102, a digital camera 201, and a recorder 202, respectively connected by a cable or wirelessly. Further, the video camera 102, the digital camera 201, and the recorder 202 may be connected to the work management device 101 through a network 210. The network 210, for example, is a local area network (LAN), a wide area network (WAN), the Internet, or the like.

The work management device 101 is a device configured to manage records obtained by an observation of the work of a worker. More specifically, for example, the work management device 101 is a computer such as a personal computer (PC), a tablet terminal, and the like.

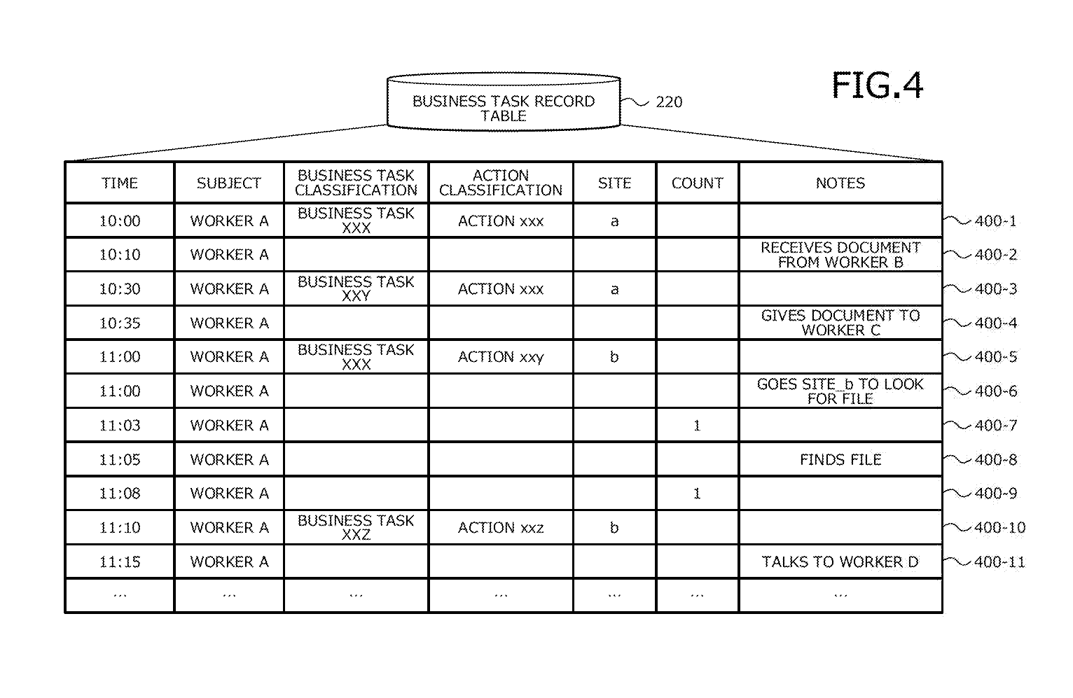

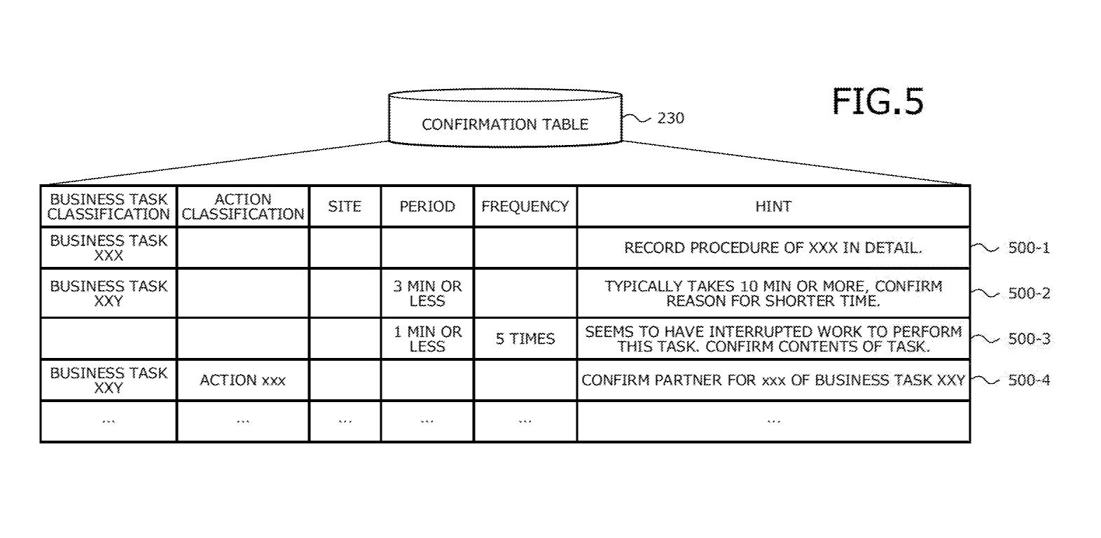

The work management device 101 further has a business task record table 220 and a confirmation table 230. An example of the contents of the respective tables will be described with reference to FIGS. 4 and 5.

The video camera 102 is a device that captures moving images. For example, the video camera 102 captures moving images by which the observer records work details of the worker. The digital camera 201 is a device that captures still images. For example, the digital camera 201 captures still images by which the observer records work details of the worker. The recorder 202 is a device that records sound. For example, the recorder 202 records the voice of the worker to record what the worker said.

Although the work management system 200 depicted in FIG. 2 is formed by independent devices including the work management device 101, the video camera 102, the digital camera 201, and the recorder 202, the work management device 101 may include a built-in function of one or more of the video camera 102, the digital camera 201, and the recorder 202.

Further, in the work management system 200 depicted in FIG. 2, although the work management device 101 has the business task record table 220 and the confirmation table 230, the network 210 may include a non-depicted server that has the business task record table 220 and the confirmation table 230.

Further, in the work management system 200 depicted in FIG. 2, although the work management device 101 is a computer such as a PC, tablet terminal, and the like, the work management device 101 may be a server configured to cause a PC, tablet terminal, and the like to display a screen (e.g., a business task record display screen 600, a detailed display graphic 700, etc. described hereinafter) created by the work management device 101.

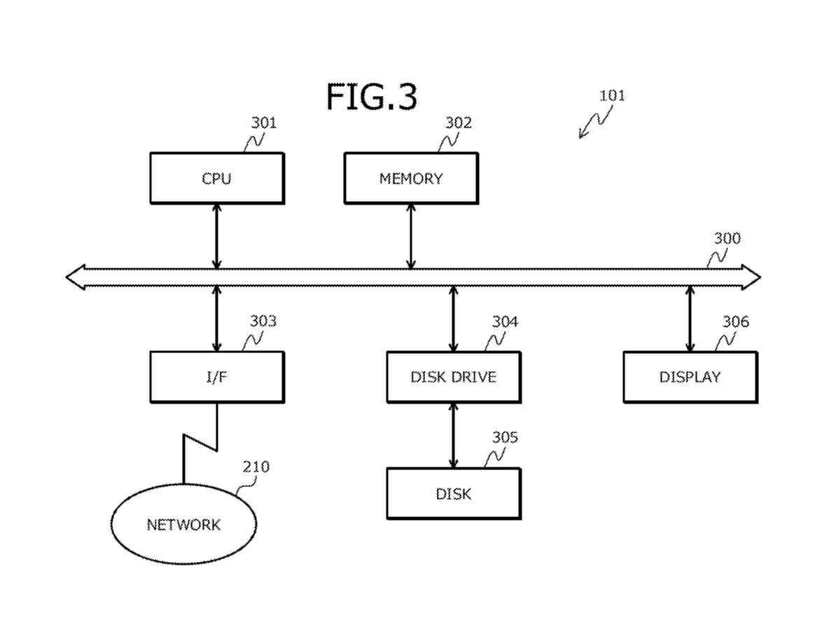

FIG. 3 is a block diagram of an example of hardware configuration of the work management device 101. In FIG. 3, the work management device 101 includes a central processing unit (CPU) 301, memory 302, an interface (I/F) 303, a disk drive 304, a disk 305, and a display 306. Further, respective components are connected by a bus 300.

Here, the CPU 301 governs overall control of the work management device 101. The memory 302, for example, includes read-only memory (ROM), random access memory (RAM), and flash ROM. More specifically, for example, the flash ROM and ROM store various types of programs and the RAM, as a storage unit, is used as work area of the CPU 301. Programs stored by the memory 302 are load onto the CPU 301, whereby encoded processes are executed by the CPU 301.

The I/F 303 is connected to the network 210 (LAN, WAN, the Internet, etc.) through a communications line, and is connected to other computers through the network 210. The I/F 303 administers an internal interface with the network 210 and controls the input and output of data with respect to other computers. The I/F 303 may be, for example, a modem, a LAN adapter, or the like.

The disk drive 304, under the control of the CPU 301, controls the reading and writing of data with respect to the disk 305. The disk 305 records data written thereto under the control of the disk drive 304. The disk 305 may be, for example, a magnetic disk, an optical disk, and the like.

The display 306 displays data such as documents, images, and functional information in addition to a cursor, icons, and a toolbox. The display 306 may be, for example, a liquid display, an organic electroluminescence (EL) display, a cathode ray tube (CRT) display, or the like. Further, the display 306 may be an input device that includes a touch panel and operates a device by a pressing of an icon displayed on the display 306.

The work management device 101, other than the configuration above, for example, may have a solid state drive (SSD), a keyboard, a mouse, a printer, etc.

FIG. 4 is a diagram depicting an example of the contents of the business task record table 220. In FIG. 4, the business task record table 220, for example, is created and updated by the work management device 101, and stored to the memory 302 or the disk 305 of the work management device 101.

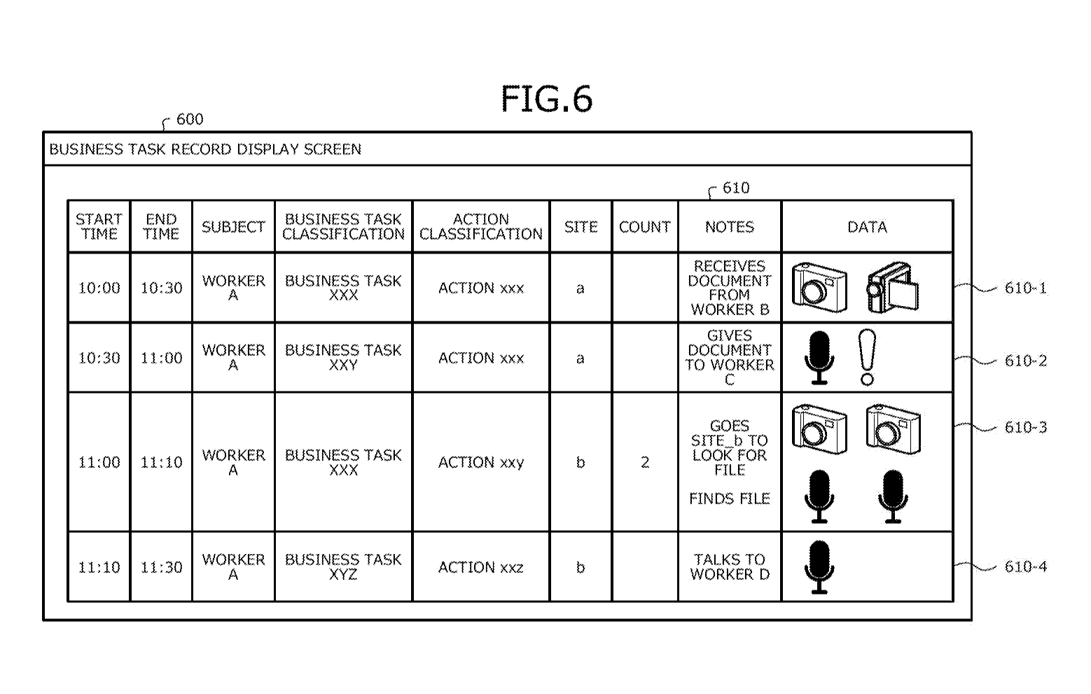

The business task record table 220 records work details of the worker observed by the observer. For example, through the business task record display screen 600 described with reference to FIG. 6, a record is added to the business task record table 220 each time the observer records work details.

The business task record table 220 has fields for items including times, subjects, business task classifications, action classifications, sites, counts, and notes. When information is set into a field of each item, the business task record table 220 stores the information as one record of business task information. For example, the business task record table 220 depicted in FIG. 4 stores records of business task information 400-1 to 400-11.

Here, a time indicates the time when the business task classification, the action classification, the site, the count, or the note was stored. For example, the time is indicated in hours and minutes. A subject indicates the name of a worker. A business task classification indicates a business task performed by the worker. An action classification indicates an action in the business task performed by the worker. A site represents the site where the worker performed the business task. A count indicates the number of times an action is performed when the worker performs the action repeatedly. A note indicates an act performed by the worker in the action indicated by the action classification.

Here, the business task record table 220 may omit the note field. In this case, notes may be stored as a text file to a storage device such as the disk 305 of the work management device 101.

In the example depicted in FIG. 4, record 400-1 indicates that worker A performed action xxx of the business task XXX at 10:00, at site_a.

FIG. 5 is a diagram depicting an example of the contents of the confirmation table 230. In FIG. 5, the confirmation table 230, for example, is created and updated by the work management device 101, and stored to the memory 302 or the disk 305 of the work management device 101.

The confirmation table 230 is a table describing hints when the observer observes a worker. For example, when the observer records a business task, an action, or a site through the business task record display screen 600, hints in the confirmation table 230 are displayed on the business task record display screen 600.

The confirmation table 230 has fields for items including business task classifications, action classifications, sites, periods, frequencies, and hints. When information is set into a field of each item, the confirmation table 230 stores the information as one record of confirmation information. For example, the confirmation table 230 depicted in FIG. 5 stores records of confirmation information 500-1 to 500-4.

Here, a business task classification represents a condition for displaying a hint for a business task performed by the worker. An action classification represents a condition for displaying a hint for an action in the business task performed by the worker. A site represents a condition for displaying a hint for the site where the worker performed the business task.

A period represents a condition for displaying a hint for the period of the work or the period of the business task performed by the worker. Here, a period of a business task is the period from the start to the end of the business task. For example, the period of a business task is the period from the recording of the business task into the business task classification field of the business task record table 220 until another business task is recorded. The period of work is the period from the start to the end of the work. A frequency represents a condition for displaying a hint for the frequency of the work or business task performed by the worker.

A hint is a hint when the observer performs the observation. For example, a hint is displayed on the business task record display screen 600 when a condition (e.g., business task classification, action classification, site, period, and frequency) is satisfied. Here, a hint may describe, for example, advice for inexperienced observers, a potential for oversight if one is unfamiliar with the work of the worker, etc.

In the example depicted in FIG. 5, record 500-1 indicates a hint for an instance where the observer has input “business task XXX” in the business task classification field of the business task record display screen 600 when observing a worker.

FIG. 6 is a diagram depicting an example of the business task record display screen 600. In FIG. 6, the business task record display screen 600 is a screen that records and displays business task details of the worker observed by the observer. For example, the observer inputs the business task details into the business task record display screen 600, whereby the input contents are recorded to the business task record table 220. For example, the business task details of the worker may be further displayed on the business task record display screen 600 by reading out information recorded in the business task record table 220. Further, for example, the business task record display screen 600 is created by the work management device 101 and displayed by the display 306 of the work management device 101.

The business task record display screen 600 has a business task record display field 610. The business task record display field 610 has fields for items including start times, end times, subjects, business task classifications, action classifications, sites, counts, notes, and data. When information is set into a field of each item, the business task record display field 610 displays the information as one business task record. For example, the business task record display field 610 depicted in FIG. 6 displays business task records 610-1 to 610-4.

Here, the business task record display field 610 is a field that records and displays the business task details of the worker observed by the observer. The start time field in the business task record display field 610 receives input of and displays the start time of a business task performed by the worker. For example, the work management device 101 may display the time at which the observer input the business task into the business task classification field of the business task record display field 610, as the start time in the business task record display field 610. Further, the observer may input the start time by tapping the start time field. In this case, the work management device 101 displays in the start time field, the time indicated by a timer of the work management device 101.

The end time field of the business task record display field 610 is a field that inputs and displays the end time of the business task performed by the worker. For example, as the end time of the previous business task, the work management device 101 may display in the end time field of the business task record display field 610, the time at which the observer enters a new business task in the business task classification field of the business task record display field 610. Further, the end time may be input by the observer tapping the end time field.

The subject field in the business task record display field 610 is a field in which information identifying the worker is input. For example, the name of the worker may be input as the information identifying the worker. Further, for example, when the observer taps the start time field, the work management device 101 may display a list of subjects, whereby the observer can input a subject by selecting a subject from the list.

The business task classification field in the business task record display field 610 is a field that inputs and displays a business task performed by the worker. For example, when the observer taps the business task classification field, the work management device 101 may display a list of business task classifications, whereby the observer can input a business task classification by selecting a business task classification from the list.

The action classification field in the business task record display field 610 is a field that inputs and displays an action in the business task performed by the worker. For example, when the observer taps the action classification field, the work management device 101 may display a list of action classifications, whereby the observer can input an action classification by selecting an action classification from the list.

The site field in the business task record display field 610 is a field that inputs and displays the site at which the worker performed the business task. For example, when the observer taps the site field, the work management device 101 may display a list of sites, whereby the observer can input a site by selecting a site from the list.

When the start time, subject, business task classification, action classification, and site of the business task record display field 610 have been input, the work management device 101 respectively sets each into the time, subject, business task classification, action classification, and site fields of the business task record table 220.

The count field in the business task record display field 610 is a field that inputs and displays the number of times an action is performed when the worker performs the action repeatedly. For example, when the observer taps the count field, the count is incremented. Further, when a count is input, the work management device 101 may set in the respective time, subject, and count fields of the business task record table 220, the time at which the count field was tapped, the concerned subject, and “1” indicating that that performance of the action is counted.

The note field in the business task record display field 610 is a field that inputs and displays an act performed by the worker in the action indicated by the action classification. Further, when a note is input, the work management device 101 may set in the respective time, subject, and note fields of the business task record table 220, the time at which the note was input, the concerned subject, the contents of the note.

The data field in the business task record display field 610 is a field that displays by a symbol, the presence of audio data, moving image data, and still image data obtained between the start time and the end time. For example, the symbol for audio data may be an icon of a microphone; the symbol for moving image data may be an icon of a video camera; and the symbol for still image data may be an icon of a digital camera.

Further, file names may be displayed as symbols. In the case of moving image data and still image data, an image may be used as a symbol.

A symbol representing data in the business task record display field 610 may be tapped, whereby sound or an image is generated by an application that corresponds to the data.

An icon to remind the observer that the worker changed the work performed in response to a comment of the observer may be displayed in the data field in the business task record display field 610.

In the example depicted in FIG. 6, record 610-1 indicates that worker A performed action xxx in the business task XXX from 10:00 to 10:30 at site_a, during which time, worker A received a document from worker B. Record 610-1 further indicates that moving image data and still image data exist.

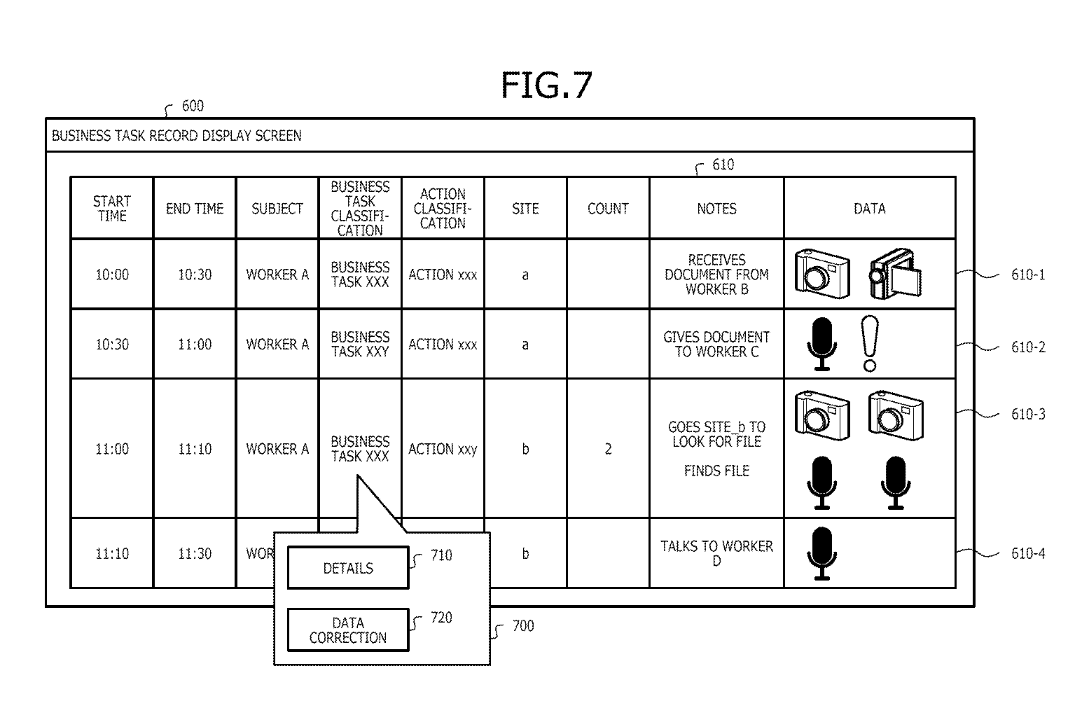

FIG. 7 is a diagram depicting an example of the detailed display graphic 700. In FIG. 7, the detailed display graphic 700 is a graphic to display details of the data displayed on the business task record display screen 600, or to correct the data. For example, the detailed display graphic 700 is displayed when data displaying details in the business task record display screen 600 or data that is to be corrected is tapped. Further, for example, the detailed display graphic 700 is created by the work management device 101 and displayed by the display 306 of the work management device 101.

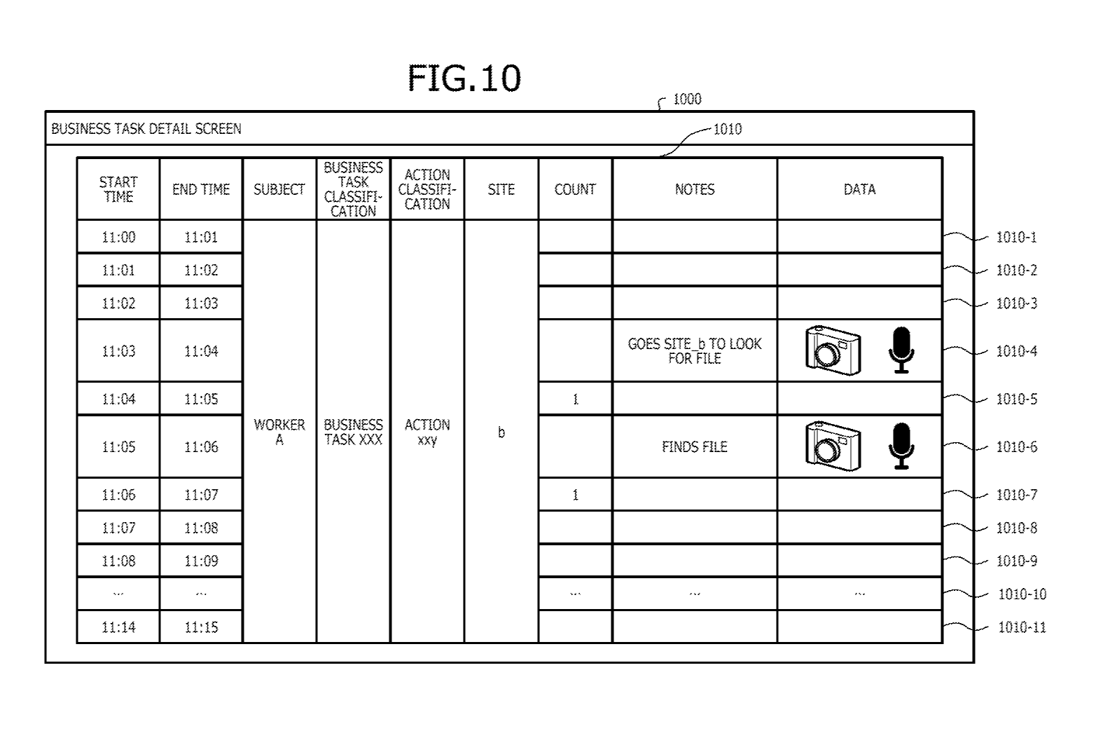

The detailed display graphic 700 has a detail button 710 and a data correction button 720. Here, the detail button 710 is a button for displaying details of a tapped field. For example, the observer taps the detail button 710, whereby a detailed screen is displayed. For example, the observer taps an item of a business task and the detail button 710, whereby a business task detail screen 1000 described with reference to FIG. 10 is displayed.

The data correction button 720 is a button for correcting the data of a tapped field. For example, the observer taps the data correction button 720, whereby a data correction screen is displayed.

The example depicted in FIG. 7 depicts the detailed display graphic 700 when the business task XXX in record 610-3 is tapped.

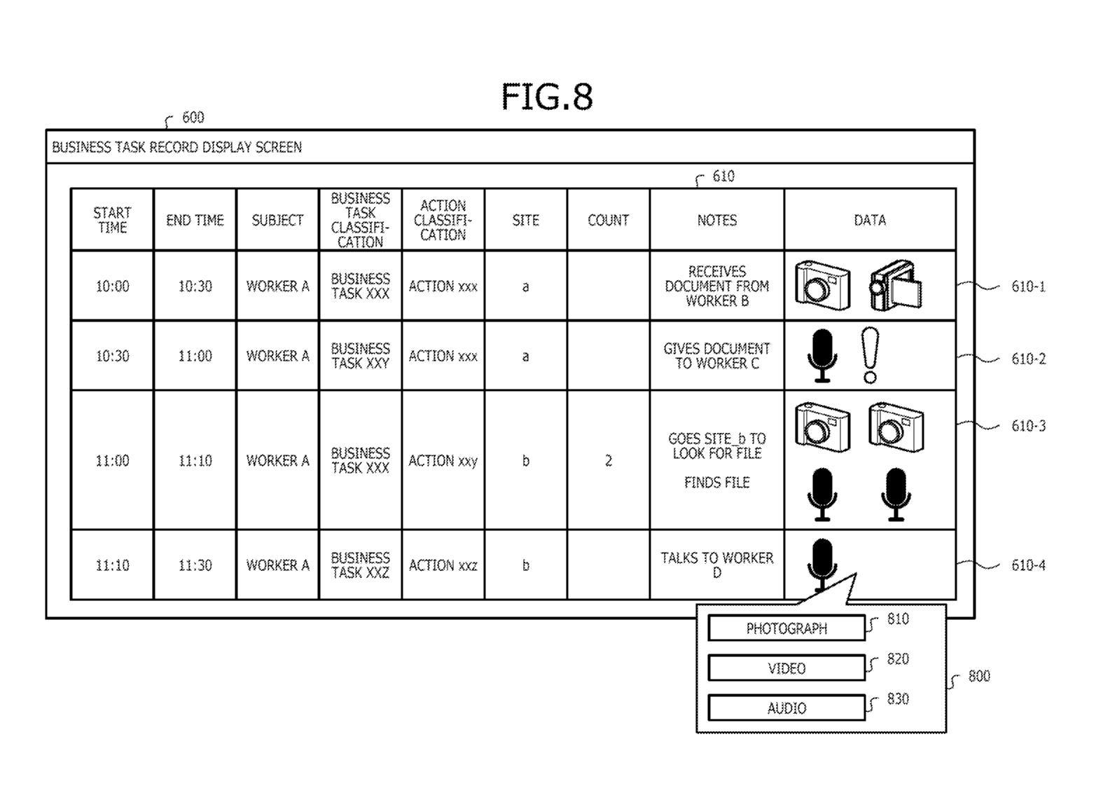

FIG. 8 is a diagram depicting an example of a data obtaining graphic 800. In FIG. 8, the data obtaining graphic 800 is a graphic displayed to obtain audio data, moving image data, and still image data of a business task recorded by the observer for a subject. For example, the data obtaining graphic 800 is displayed when the observer taps the data field of a record that corresponds to the business task currently under observation. Further, for example, the data obtaining graphic 800 is created by the work management device 101 and displayed by the display 306 of the work management device 101.

The data obtaining graphic 800 has a photograph button 810, a moving image button 820, and an audio image button 830. Here, the photograph button 810 is a button for obtaining a still image. For example, the observer taps the photograph button 810, whereby an application that obtains a still image is invoked.

The moving image button 820 is a button for obtaining moving image data and the audio image button 830 is a button for obtaining audio data. Further, the work management device 101 may insert at the position tapped, a symbol that corresponds to the audio data, moving image data, and still image data obtained by the photograph button 810, the moving image button 820, and the audio image button 830, respectively.

The example depicted in FIG. 8 depicts the data obtaining graphic 800 when the data field of record 610-4 is tapped.

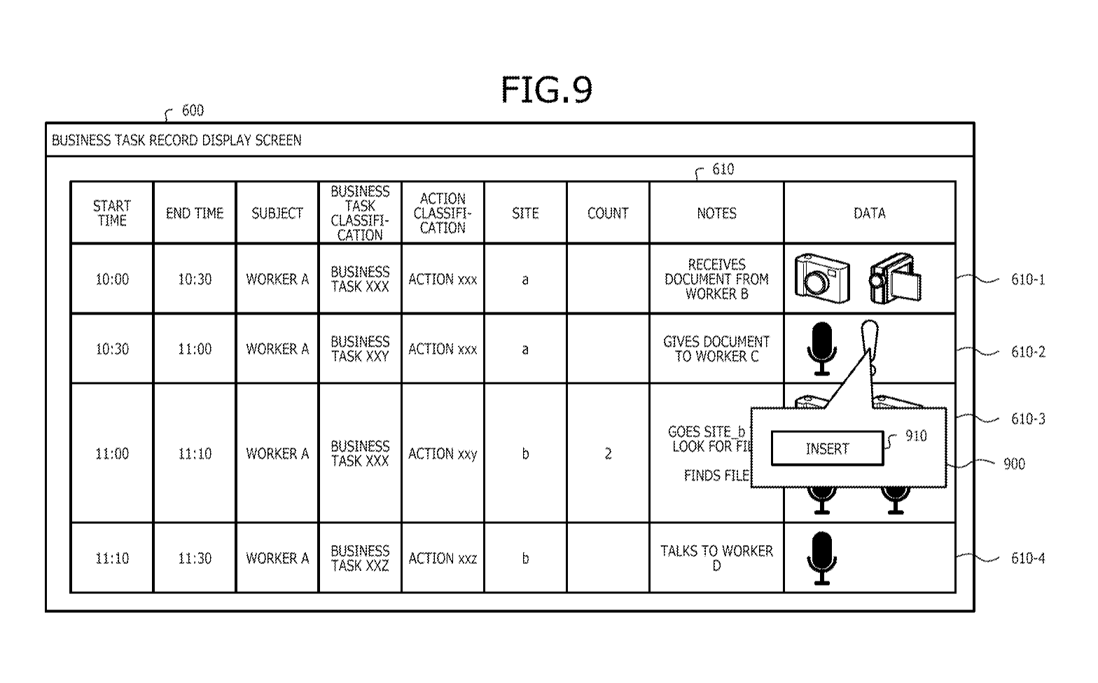

FIG. 9 is a diagram depicting an example of a data insertion graphic 900. In FIG. 9, the data insertion graphic 900 is a graphic displayed to display a symbol for audio data, moving image data, and still image data concerning a business task of the subject and recorded by the observer. For example, the data insertion graphic 900 is displayed when the data field of a record is tapped. Further, for example, the data insertion graphic 900 is created by the work management device 101 and displayed by the display 306 of the work management device 101.

The data insertion graphic 900 has an insertion button 910. Here, the insertion button 910 is a button for displaying the symbol of audio data, moving image data, and still image data obtained between the start time and the end time of a tapped record.

The example depicted in FIG. 9 depicts the data insertion graphic 900 when the data field of 610-2 is tapped.

FIG. 10 is a diagram depicting an example of the business task detail screen 1000. In FIG. 10, the business task detail screen 1000 is a screen displaying details of business tasks of the worker observed by the observer. For example, the business task detail screen 1000 is displayed when in the business task record display screen 600, the observer taps the business task classification field in the business task record display field 610, and taps the detail button 710 of the detailed display graphic 700. The business task detail screen 1000 displays the details of a business task of the business task classification tapped by the observer. Further, for example, the business task detail screen 1000 is created by the work management device 101 and displayed by the display 306 of the work management device 101.

The business task detail screen 1000 has a business task detail display field 1010. The business task detail display field 1010 has fields for items including start times, end times, subjects, business task classifications, action classifications, sites, counts, notes, and data. When information is set into a field of each item, the business task detail display field 1010 displays the information as one record of the business task detail information. For example, the business task detail display field 1010 depicted in FIG. 10 displays business task detail information 1010-1 to 1010-11 as records.

Here, the business task detail display field 1010 is a field that displays details of a business task of the worker observed by the observer. For example, the business task of the worker is displayed in 1-minute units. More specifically, for example, the start time and the end time are displayed in 1-minute intervals and the contents of the business task performed by the worker during this time period are displayed.

The subject field of the business task detail display field 1010 is a field that displays information that identifies the worker. The business task classification field of the business task detail display field 1010 is a field that specifies the business task performed by the worker. The business task classification field displays the business task classification tapped in the business task classification field of the business task record display field 610. The action classification field in the business task detail display field 1010 is a field that displays an action in the business task performed by the worker.

The site field in the business task detail display field 1010 is a field that displays the site at which the worker performed the business task. Further, the count field in the business task detail display field 1010 is a field that displays “1” when the worker has performed the same action.

The note field in the business task detail display field 1010 is a field that displays an act performed by the worker in the action of the action classification. The data field in the business task detail display field 1010 is a field that displays by a symbol, the presence of audio data, moving image data, and still image data for which the obtaining time is between the start time and the end time.

In the example depicted in FIG. 10, record 1010-4 indicates that worker A performed action xxy in the business task XXX from 11:03 to 11:04 at site_b, during which time, worker A moved to site_b to look for a file. Record 1010-4 further indicates that audio data and still image data exist.

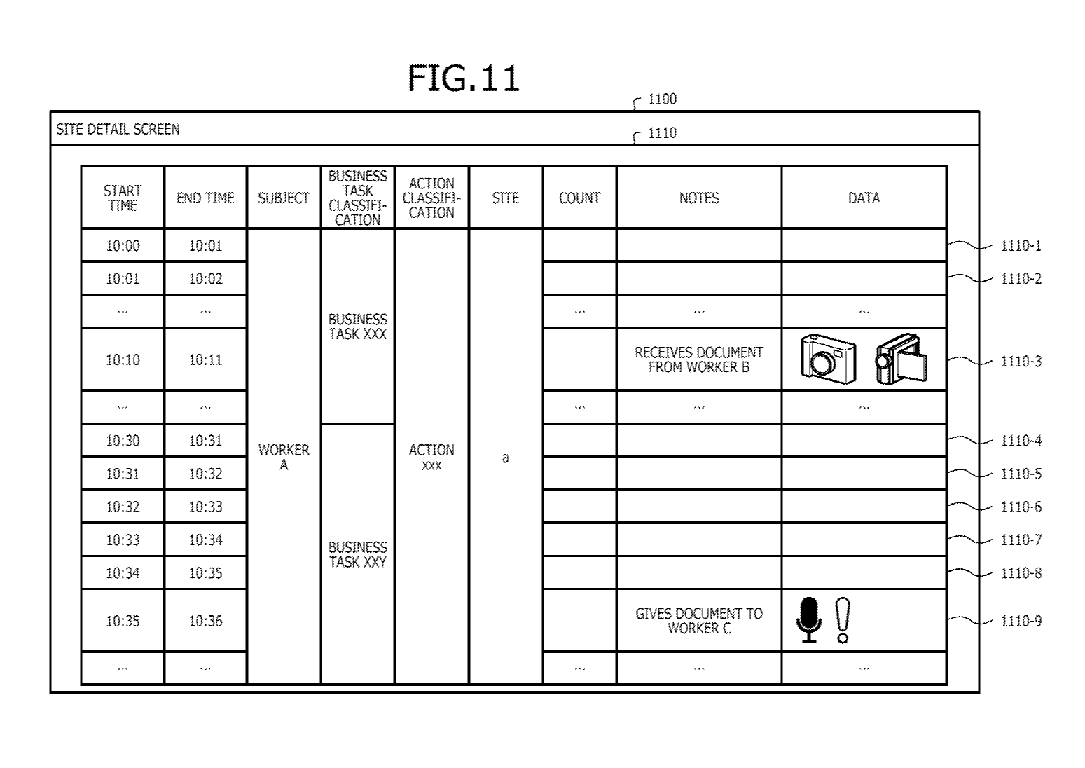

FIG. 11 is a diagram depicting an example of a site detail screen 1100. In FIG. 11, the site detail screen 1100 is a screen that displays site details of business tasks of the worker observed by the observer. For example, the site detail screen 1100 is displayed when in the business task record display screen 600, the observer taps the site field of the business task record display field 610 and taps the detail button 710 of the detailed display graphic 700. Further, the site detail screen 1100 displays details of business tasks performed at the site tapped by the observer. Further, for example, the site detail screen 1100 is created by the work management device 101 and displayed by the display 306 of the work management device 101.

The site detail screen 1100 has a site detail display field 1110. The site detail display field 1110 has fields for items including start times, end times, subjects, business task classifications, action classifications, sites, counts, notes, and data. When information is set into a field of each item, the site detail display field 1110 displays the information as one record of site detail information. For example, the site detail display field 1110 depicted in FIG. 11 displays site detail information 1110-1 to 1110-9 as records.

Here, the site detail display field 1110 is a field that displays details of business tasks performed by the worker at the site tapped in the business task record display screen 600 by the observer. For example, the sites of the business tasks of the worker are displayed in 1-minute units. More specifically, for example, the start time and the end time are displayed in 1-minute intervals and the contents of the business task performed by the worker during this time period are displayed.

The subject, business task classification, action classification, site, count, note, and data fields in the site detail display field 1110 respectively display the same contents as the subject, business task classification, action classification, site, count, note, and data fields in the business task detail display field 1010. Here, the site field in the site detail display field 1110 displays the site tapped in the business task record display screen 600 by the observer.

In the example depicted in FIG. 11, record 1110-3 indicates that worker A performed the action xxx in the business task XXX from 10:10 to 10:11 at site_a, during which time, worker A received a document from worker B. Record 1110-3 further indicates that moving image data and still image data exist.

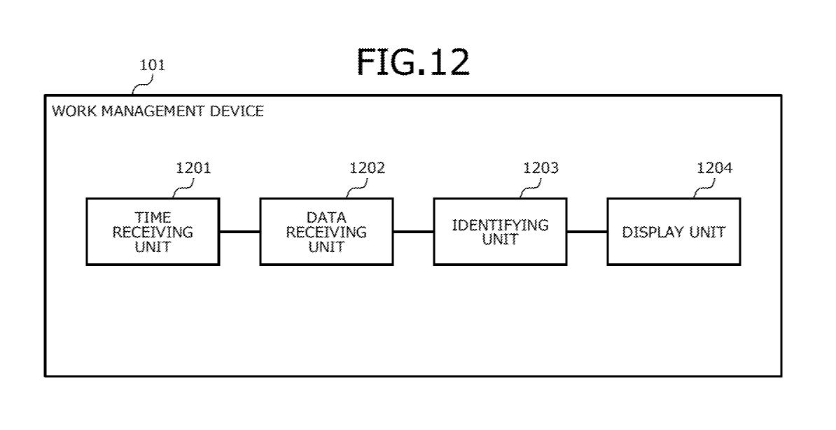

FIG. 12 is a block diagram of a functional configuration of the work management device 101. In FIG. 12, the work management device 101 is configured to include a time receiving unit 1201, a data receiving unit 1202, an identifying unit 1203, and a display unit 1204. A control unit that includes the data receiving unit 1202, the identifying unit 1203, and the display unit 1204, more specifically, for example, implements such functions by programs stored in a storage device such as the memory 302 depicted in FIG. 3 being executed by the CPU 301. Processing results of the functional units, for example, are stored to a storage device such as the memory 302 depicted in FIG. 3.

The time receiving unit 1201 has a function of receiving information that specifies the start time and the end time of work. For example, the time receiving unit 1201 receives as the information, a tapping of the data field in the business task record display screen 600. Further, the time receiving unit 1201 obtains the start time and the end time of a tapped item.

The time receiving unit 1201 may receive a tapping of the photograph button 810, the moving image button 820, or the audio image button 830 in the data obtaining graphic 800, invoke a related application, and obtain the invocation time of the application.

The data receiving unit 1202 has a function of receiving still images, moving images, and audio data that include an obtaining time. For example, the data receiving unit 1202 receives moving images, still images, and audio data from the video camera 102, the digital camera 201, and the recorder 202, which are external devices of the work management device 101. Further, the data receiving unit 1202 may receive still images, moving images, and audio data from a camera and recorder built into the work management device 101.

The data receiving unit 1202 may receive input of a subject, business task classification, action classification, site, count, and note in the business task record display screen 600.

The identifying unit 1203 has a function of identifying among the still images, moving images, and/or audio data received by the data receiving unit 1202, a still image, moving image, and/or audio data for which the obtaining time is between the start time and the end time specified by the information received by the time receiving unit 1201.

For example, the identifying unit 1203 obtains the data from a file output path where a file recording the still images, moving images, and/or audio data resides. For example, the identifying unit 1203 identifies in the obtained file, a file that was created between the start time and the end time of the work.

The identifying unit 1203, when the invocation time of an application is obtained, may identify a still image, moving image, and/or audio data obtained after the invocation time of the application.

When the data receiving unit 1202 has received input of a subject, business task classification, action classification, site, count, and note in the business task record display screen 600, the identifying unit 1203 may determine whether the input contents are in the confirmation table 230. The identifying unit 1203 may determine if the input contents are present in the confirmation table 230, if no period or frequency condition exists, or if the input contents satisfy a period and/or frequency condition. The identifying unit 1203 identifies a hint displayed in this case.

The display unit 1204 has a function of arranging and displaying in an area that corresponds to a time interval demarcated by the start time and the end time, a symbol that corresponds to the still image, moving image, and/or audio data identified by the identifying unit 1203.

For example, the display unit 1204 may display a symbol of a file at the position of a tap received by the time receiving unit 1201. The display unit 1204 has a counter and when the identifying unit 1203 identifies multiple still images, moving images, and/or audio data, increments the counter for each display thereof, and displays symbols of the still images, moving images, and/or audio data so as not to overlap.

Further, for example, when the identifying unit 1203 identifies a hint, the display unit 1204 may display the hint so as to overlap the business task record display screen 600. Further, when the subject changes the work performed in response to a comment of the observer based on the hint, the display unit 1204 may display an icon in the data field of the business task record display screen 600.

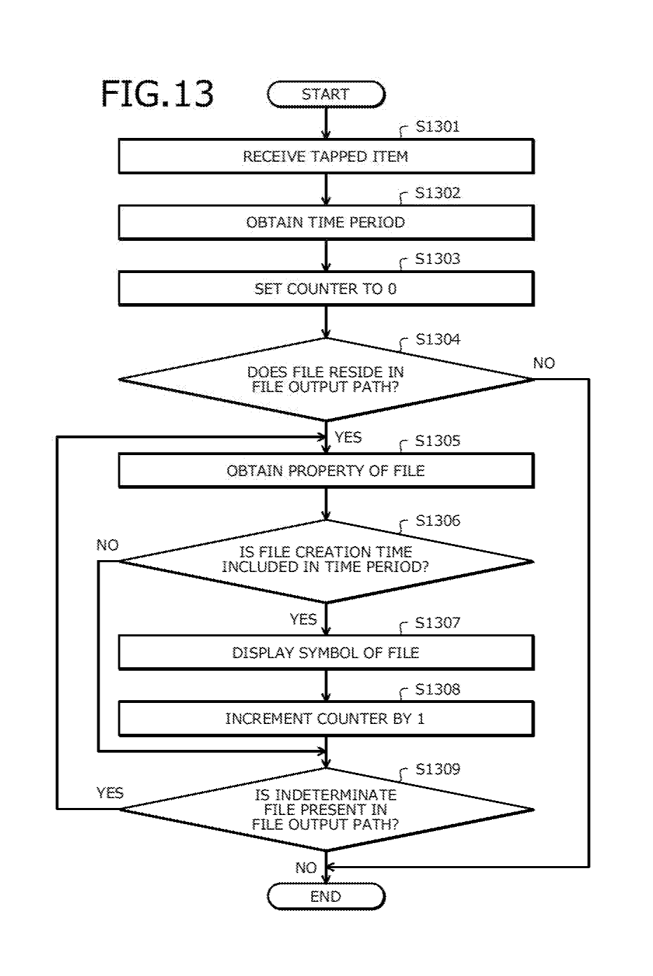

FIG. 13 is a flowchart of an example of a procedure of a data insertion process by the work management device 101. In FIG. 13, the work management device 101 receives the tapping of an item in the business task record display screen 600 (step S1301). For example, the work management device 101 receives the tapping of the insertion button 910 in the data insertion graphic 900.

The work management device 101 obtains a time period (step S1302). For example, the work management device 101 obtains the start time and the end time of a tapped item. Thereafter, the work management device 101 sets a counter to 0 (step S1303). Here, the counter is used so that when there are multiple symbols displayed in the data field of the business task record display screen 600, the symbols are not displayed overlapping each other.

The work management device 101 determines whether a file resides in a file output path (step S1304). The file output path is a site where a file recording still images, moving images, and audio data resides and is provided to the work management device 101 in advance. If no file resides in the file output path (step S1304: NO), there is no data to be inserted and therefore, the process of the work management device 101 ends.

If file resides in the output path (step S1304: YES), the work management device 101 obtains properties of the file (step S1305). For example, the work management device 101 obtains a file creation time as a property.

The work management device 101 determines whether the file creation time is included in the time period (step S1306). For example, the work management device 101 determines whether the file creation time is included in the time period based on the file creation time being after the start time and before the end time. When the file creation time is not included in the time period (step S1306: NO), the process of the work management device 101 transitions to step S1309.

When the file creation time is included in the time period (step S1306: YES), the work management device 101 displays the symbol of the file in the data field of the business task record display screen 600 (step S1307). For example, the work management device 101 displays an icon of a file as the symbol of the file. Further, the work management device 101 determines based on the counter, the position where the symbol of the file is to be displayed. For example, the work management device 101 displays the symbols of files arranged horizontally so as to not overlap each other. Thereafter, the work management device 101 increments the counter by 1 (step S1308).

The work management device 101 determines whether in the file output path, an indeterminate file is present (step S1309). Here, an indeterminate file is a file for which determination of whether the file creation time is included in the time period has not yet been performed at step S1306.

If an indeterminate file is present (step S1309: YES), the work management device 101 returns to step S1305. If no indeterminate file is present (step S1309: NO), the processing by the work management device 101 ends.

Thus, a series of operations according the flowchart ends. By executing the flowchart, the work management device 101 can display the symbol of data obtained from the start time to the end time of a tapped item.

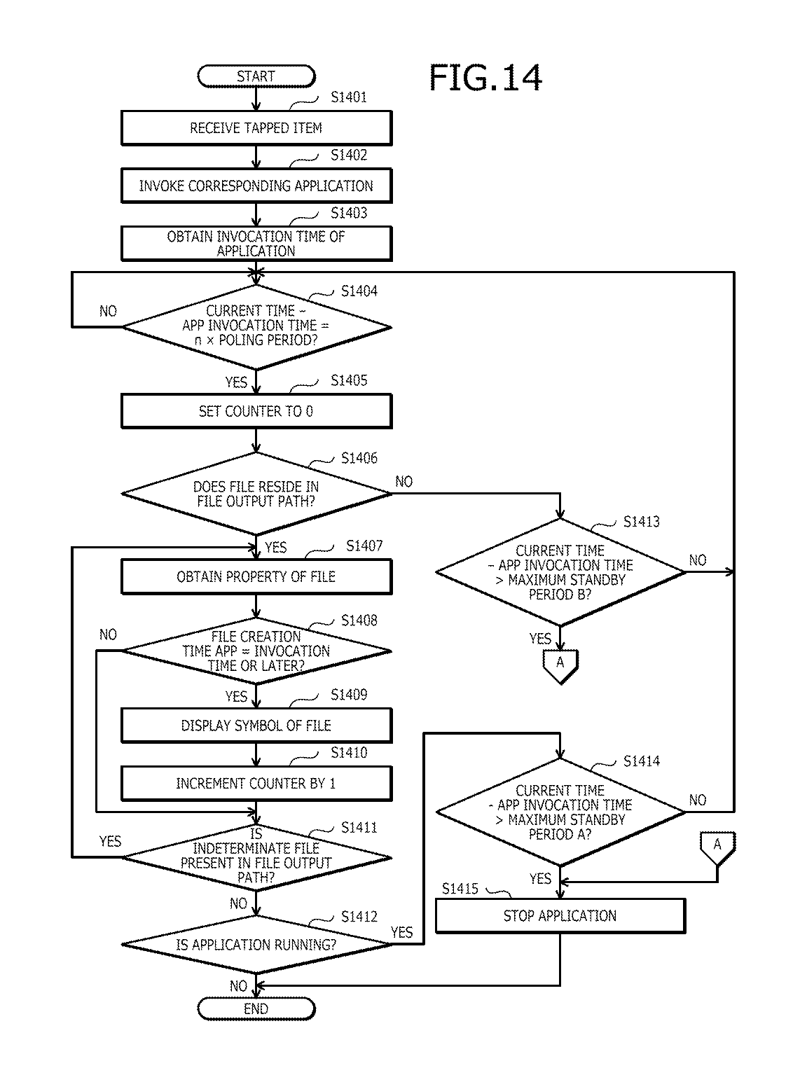

FIG. 14 is a flowchart of an example of a procedure of a data display process of the work management device 101. In FIG. 14, the work management device 101 receives a tapping of an item in the business task record display screen 600 (step S1401). For example, the work management device 101 receives a tapping of the photograph button 810, the moving image button 820, or the audio image button 830 in the data obtaining graphic 800.

The work management device 101 invokes a corresponding application (step S1402). For example, if the photograph button 810 has been tapped, the work management device 101 invokes an application that obtains a still image by the digital camera 201. Further, if the moving image button 820 has been tapped, the work management device 101 invokes an application that obtains a moving image by the video camera 102. Further, if the audio image button 830 has been tapped, the work management device 101 invokes an application that obtains sound by the recorder 202.

The work management device 101 obtains an invocation time of the application (step S1403). Here, the work management device 101 stores the obtained invocation time to the memory 302 of the work management device 101, for example.

The work management device 101 determines whether current time-app invocation time=n×poling period is true (step S1404). Here, app invocation time is the invocation time of the application; and n is an integer of 1 or greater. The poling period is a preset period and, for example, may be 3 seconds. The determination is performed so that the work management device 101 periodically obtains the file output by the application. As a result, a work management program running on the work management device 101 does not need to be linked with the application and the application does not need to be modified.

If the current time-app invocation time=n×poling period is not true (step S1404: NO), the work management device 101 returns to step S1404. If the current time-app invocation time=n×poling period is true (step S1404: YES), the work management device 101 sets the counter to 0 (step S1405).

The work management device 101 determines whether a file resides in the file output path (step S1406). The file output path is a site where a file of the still image, moving image, and audio data output by the application resides and is provided to the work management device 101 in advance.

If no file resides in the file output path (step S1406: NO), the work management device 101 determines whether the current time-app invocation time>maximum standby period B is true (step S1413). Here, the maximum standby period B is a preset period. This determination is performed to enable the work management device 101 to terminate the application when the observer has forgotten to terminate the application.

If the current time-app invocation time>maximum standby period B is true (step S1413: YES), the work management device 101 transitions to step S1415. If the current time-app invocation time>maximum standby period B is not true (step S1413: NO), the work management device 101 returns to step S1404.

If a file resides in the file output path (step S1406: YES), the work management device 101 obtains a property of the file (step S1407). For example, the work management device 101 obtains the file creation time as the property.

The work management device 101 determines if the file creation time is the app invocation time or later (step S1408). If the file creation time is not the app invocation time or later (step S1408: NO), the work management device 101 transitions to step S1411.

If the file creation time is app invocation time or later (step S1408: YES), the work management device 101 displays a symbol of the file (step S1409). For example, the work management device 101 displays an icon of a file as the symbol of the file. Further, the work management device 101 determines the position where the symbol of the file is to be displayed, based on the counter. Thereafter, the work management device 101 increments the counter by 1 (step S1410).

The work management device 101 determines whether an indeterminate file is present in the file output path (step S1411). Here, an indeterminate file is a file for which determination at step S1408 has not yet been performed.

If an indeterminate file is present (step S1411: YES), the work management device 101 returns to step S1407. If no indeterminate file is present (step S1411: NO), the work management device 101 determines whether an application is running (step S1412). If no application is running (step S1412: NO), the process of the work management device 101 ends.

If an application is running (step S1412: YES), the work management device 101 determines whether the current time-app invocation time>maximum standby period A is true (step S1414). Here, the maximum standby period A is a preset period. This determination is performed to enable the work management device 101 to terminate the application when the observer has forgotten to terminate application.

If the current time-app invocation time>maximum standby period A is not true (step S1414: NO), the work management device 101 returns to step S1404. If the current time-app invocation time>maximum standby period A is true (step S1414: YES), the work management device 101 stops the application (step S1415).

Thus, a series of operations according to the flowchart ends. By executing the flowchart, the work management device 101 can obtain data at a position of a tapped item and display a symbol of the obtained data.

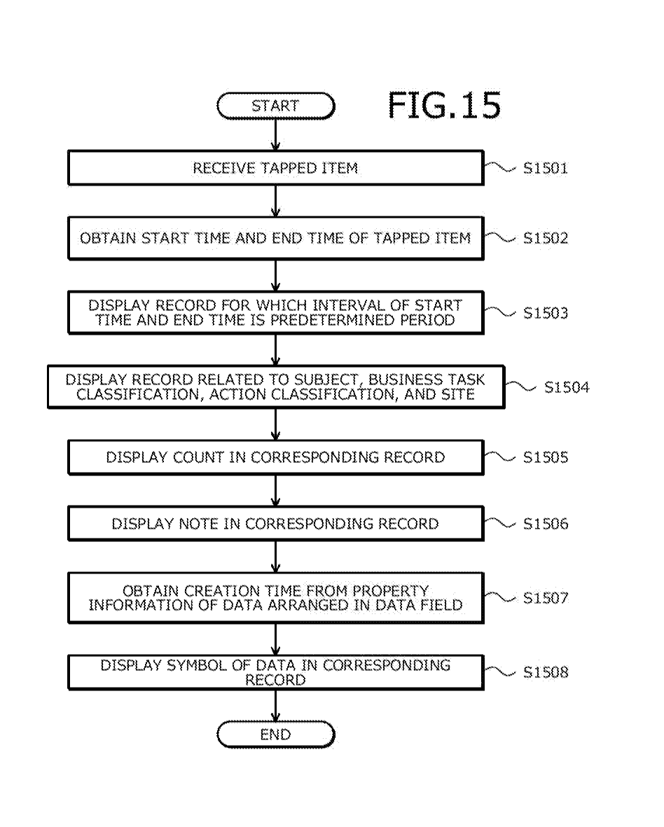

FIG. 15 is a flowchart of an example of a procedure of a business task detail screen creation process of the work management device 101. In FIG. 15, the work management device 101 receives a tapped item in the business task record display screen 600 (step S1501). For example, the work management device 101 receives the tapping of the detail button 710 in the detailed display graphic 700.

The work management device 101 obtains the start time and the end time of the tapped item (step S1502). For example, the work management device 101 obtains the start time and the end time of the record of a position tapped.

The work management device 101 displays a record for which an interval of the start time and the end time is a predetermined period (step S1503). For example, the predetermined period is 1 minute and the work management device 101 creates records for which the interval of the start time and the end time is 1 minute.

The work management device 101 displays a record related to the subject, business task classification, action classification, and site (step S1504). For example, the work management device 101 displays based on the time in the business task record table 220, the subject, business task classification, action classification, and site in each record. Here, when the subject, business task classification, action classification, and site are the same in multiple records, the work management device 101 may display the records collectively as one.

The work management device 101 displays a count in a corresponding record (step S1505). For example, the work management device 101 displays the count in a record that corresponds to the time when the count was recorded, in the business task record table 220.

The work management device 101 displays a note in a corresponding record (step S1506). For example, the work management device 101 displays a note in a record that corresponds to the time when the note was recorded, in the business task record table 220. Further, when the note is recorded as a text file, the work management device 101 displays the note in a record that corresponds to the time stamp of the text file.

The work management device 101 obtains a creation time from property information of the data arranged in the data field (step S1507). The work management device 101 displays a symbol of the data in a corresponding record (step S1508). Here, the data arranged in the data field is one of audio data, moving image data, and still image data.

Thus, a series of operations according the flowchart ends. By executing the flowchart, the work management device 101 can display a detailed screen (for example, the business task detail screen 1000, the site detail screen 1100) for a tapped item.

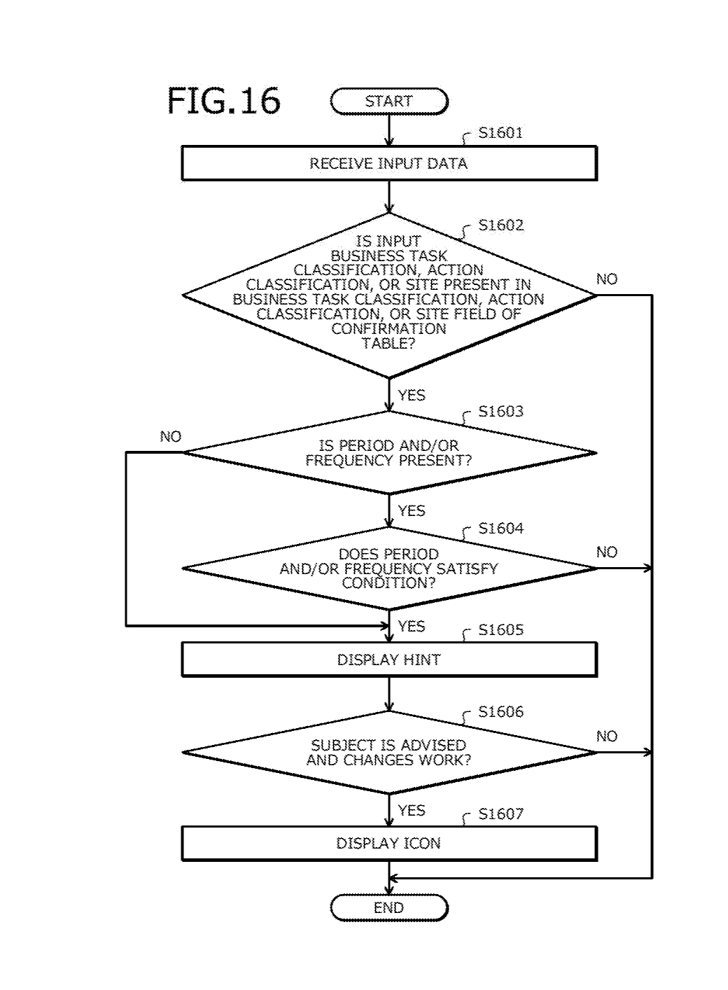

FIG. 16 is a flowchart of an example of a procedure of a confirmation process of the work management device 101. In FIG. 16, the work management device 101 receives input data, in the business task record display screen 600 (step S1601). For example, the work management device 101 receives input of one of a business task classification, action classification, site, and count in the business task record display screen 600.

The work management device 101 determines whether the input business task classification, action classification, or site is present in a business task classification, action classification, of site field of the confirmation table 230 (step S1602). If the input business task classification, action classification, or site is not present in a business task classification, action classification, or site field of the confirmation table 230 (step S1602: NO), the work management device 101 ends the process.

If the input business task classification, action classification, or site is present in a business task classification, action classification, or site field of the confirmation table 230 (step S1602: YES), the work management device 101 determines whether in a record in which the business task classification, action classification, of site is present, a period and/or frequency is present (step S1603). If no period or frequency is present (step S1603: NO), the work management device 101 transitions to step S1605.

If a period and/or frequency is present (step S1603: YES), the work management device 101 determines whether the period and/or frequency satisfies a condition (step S1604). For example, when a period is present, the work management device 101 determines whether the period that the business task of the business task classification was performed, the period that the action of the action classification was performed, or the period that the subject was at the site where the business task or action was performed, satisfies a period condition. Further, for example, the work management device 101 may calculate from the start time and the end time, the period that the business task of the business task classification was performed, the period that the action of the action classification was performed, or the period that the subject was at the site where the business task or action was performed.

Further, for example, when a frequency is present, the work management device 101 determines whether the count exceeds the frequency. The work management device 101 may calculate the count by counting the number of start times when the worker performed the same action.

If neither the period nor the frequency satisfy a condition (step S1604: NO), the work management device 101 ends the process. If the period and/or the frequency satisfy a condition (step S1604: YES), the work management device 101 displays a hint for observing the business task (step S1605). For example, the work management device 101 displays the hint to overlap the business task record display screen 600.

The work management device 101 determines if the subject is advised and changes the work (step S1606). If the subject does not change the work (step S1606: NO), the work management device 101 ends the process.

If the subject changes the work (step S1606: YES), the work management device 101 displays an icon (step S1607). The work management device 101 displays the icon in the data field of the business task record display screen 600 so that the observer does not forget that the subject changed the work. The icon, for example, may be an exclamation point “!”.

Further, concerning a change of the work of the subject, the observer may extend the end time of the period that the business task of the business task classification was performed, the end time of the period that the action of the action classification was performed, or the period that the subject was at the site where the business task or the action was performed. In this case, the work management device 101 may again display a symbol of the file in the data field of the business task record display screen 600. The process in this case is identical to the data insertion process procedure depicted in FIG. 13 and therefore, is not further described here.

Thus, a series of operations according the flowchart ends. By executing the flowchart, the work management device 101 can display for observer, hints to be used when observing a business task.

As described, the work management device 101 receives information that specifies the start time and the end time of work, and audio data or video data that includes the obtaining time thereof. The work management device 101 identifies among the received audio data or video data, audio data or video data for which the obtaining time is between the start time and the end time specified by the received information. The work management device 101 arranges and displays in an area that corresponds to the time interval demarcated by the start time and the end time, a symbol that corresponds to the identified audio data or video data.

As a result, the work management device 101 can visually display for which aspect of the work the audio data or video data was recorded. Therefore, the observer can point out to the worker, the aspect of the work for which the audio data or video data was recorded.

Further, since the work management device 101 associates the audio data or video data and the work, the observer need not organize the audio data or video data, reducing the data managing steps of the observer.

The work management device 101 calculates from the start time and the end time, the period that the work was performed and corresponding to whether the calculated period is longer than or shorter than a predetermined period, may associate and display the work and information related to the work.

Thus, the work management device 101 can notify the observer that the period over which the work was performed differs from that in the past. Thus, in the observation, the observer can, for example, ask the worker why the work period differs from that in the past.

The work management device 101 associates the work with a symbol indicating that the end time has been changed, when after having associated and displayed the work and the information related to the work, the work management device 101 receives information changing the end time. Further, the work management device 101 identifies among received audio data or video data, audio data or video data for which the obtaining time is between the start time and the changed end time. The work management device 101 displays in an area that corresponds to the time interval demarcated by the start time and the changed end time, a symbol that corresponds to the identified audio data or video data.

As a result, the work management device 101 can record that the worker changed the work consequent to the observer advising the worker that the period over which the work was performed differs from that in the past. Further, when the work period has been extended consequent to the changing of the work, a symbol can be displayed corresponding to the extended work period. Therefore, the work management device 101 can display for which work audio data or video data was recorded, even when the work period has been extended.

The work management device 101, corresponding to reception of information that specifies the start time of work, can associate the work and information related to the work, when the number of times that the work was performed is calculated and the calculated number exceeds a predetermined count.

As a result, the work management device 101 can notify the observer that the number of times that the work was performed differs from that in the past. Thus, in the observation, the observer can, for example, ask the worker why the work count differs from that in the past.

The work management method described in the present embodiment may be implemented by executing a prepared program on a computer such as a personal computer and a workstation. The work management program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the invention, an effect is achieved in that indication of the aspect of work for which audio data and video data were recorded can be displayed visually.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a work management program that causes a computer to execute a process comprising:
receiving information that specifies a start time and an end time of work;
receiving audio data or video data that includes an obtaining time thereof;
identifying among the received audio data or video data, audio data or video data for which the obtaining time is between the start time and the end time specified by the received information; and
displaying at an area that corresponds to a time interval demarcated by the start time and the end time, a symbol that corresponds to the identified audio data or video data.

2. The non-transitory, computer-readable recording medium according to claim 1, the process further comprising:
calculating from the start time and the end time, a period during which the work is performed;
associating and displaying the work and information related to the work, when the calculated period is longer or shorter than a predetermined period.

3. The non-transitory, computer-readable recording medium according to claim 2, the process further comprising:
associating and displaying the work and a symbol that indicates that the end time has been changed, when after associating and displaying the work and the information related to the work, information changing the end time is received;
identifying among the received audio data or video data, audio data or video data that includes an obtaining time that is between the start time and the changed end time; and
displaying in an area that corresponds to a time interval demarcated by the start time and the changed end time, a symbol that corresponds to the identified audio data or video data.

4. The non-transitory, computer-readable recording medium according to claim 1, the process further comprising:
calculating corresponding to reception of the information that specifies the start time of the work, a number of times that the work is performed; and
associating and displaying the work and information related to the work, when the calculated number of times exceeds a predetermined count.

5. A work management method comprising:
receiving by a computer, information that specifies a start time and an end time of work;
receiving by the computer, audio data or video data that is obtained by one of a recorder and a camera at a worksite and includes an obtaining time;
identifying by the computer and among the received audio data or video data, audio data or video data for which the obtaining time is between the start time and the end time specified by the received information; and
displaying by the computer and at an area that corresponds to a time interval demarcated by the start time and the end time, a symbol that corresponds to the identified audio data or video data.

6. A work management system comprising:
a recorder that obtains audio data;
a camera that obtains video data; and
work management processor configured to:
receive information that specifies a start time and an end time of work;
receive audio data or video data that is obtained by one of the recorder and the camera at a worksite and includes an obtaining time thereof;
identify among the received audio data or video data, audio data or video data for which the obtaining time is between the start time and the end time specified by the received information; and
display at an area that corresponds to a time interval demarcated by the start time and the end time, a symbol that corresponds to the identified audio data or video data.
